(19) United States
(12) Patent Application Publication
(10) Pub. No.: US 2017/0333737 A1
(43) Pub. Date: Nov. 23, 2017

(54) WEARABLE AIR PURIFICATION DEVICE

(71) Applicant: KONINKLIJKE PHILIPS N.V., EINDHOVEN (NL)

(72) Inventors: RUI KE, EINDHOVEN (NL); CHRISTIAAN ZIMMER, EINDHOVEN (NL); HENDRIK RICHARD JOUSMA, EINDHOVEN (NL); THANH TRUNG NGUYEN, EINDHOVEN (NL); GERBEN KOOIJMAN, EINDHOVEN (NL)

(21) Appl. No.: 15/533,386

(22) PCT Filed: Dec. 15, 2015
(86) PCT No.: PCT/EP2015/079676

§ 371 Date: Jun. 6, 2017

(30) Foreign Application Priority Data
Dec. 19, 2014 (CN) PCT/CN2014/094366
Jan. 30, 2015 (EP) 15153240.5

(51) Int. Cl. A62B 23/02; A62B 7/10; A62B 18/00; A62B 18/02

(52) U.S. Cl. CPC A62B 23/02; A62B 18/02; A62B 7/10; A62B 18/003; A62B 18/006

(57) ABSTRACT

The invention provides a wearable air purification device which actively generates a propelled stream of purified air for direct delivery to a region proximal to a user's mouth or nose for their immediate inhalation. An air chamber comprises a flexible diaphragm adapted to fluctuate between two extreme positions, thereby altering the volume within the chamber and alternately sucking and blowing air into and out of the chamber. Filtration elements are arranged in said air chamber. The filtration elements are arranged so as to make fluid communication with air displaced into the air chamber and, to make fluid communication with air displaced out of said chamber so that air is cleaned as it passes both into, and out of, the air chamber. The filtration elements actively remove particulate or gaseous pollutants. Embodiments of the invention may comprise a plurality of such air chamber assemblies, arranged so as to collectively deliver a continuous flow of air to a breathing zone of the user.

### FIELD OF THE INVENTION

The invention relates to a wearable air purification or filter device and in particular a powered device which avoids the need for the user to breath heavily through a filter.

### BACKGROUND OF THE INVENTION

Particulate matter (PM10 and PM2.5) and harmful gases (such as SO₂, NOₓ, CO, and O₃) are globally identified as the major pollutants in ambient urban environments. In recent years, the concentrations of these pollutants have frequently reached highly dangerous levels in many large cities, creating acute health risks for inhabitants and leading to a very urgent need for breathing protection for people having daily outdoor activities.

Mask-based technology is often the first choice for passive breathing protection. Although filter masks are very lightweight, and in that regard favorable as a wearable solution, they are at the same time uncomfortable to wear due to the high breathing resistance experienced by users.

To avoid the problem of breathing resistance, other solutions to wearable air-purification include power-assisted neck-worn devices, which propel, by use of a fan element, filtered air from a purifier unit positioned below a user's head, upward toward their mouth and nose. In this way, clean air is actively delivered to the user for inhalation, but without the discomfort of having to breathe through a mask.

Although such solutions successfully eliminate the breathing resistance issues, they are far from satisfactory in terms of efficiency. In particular, such “on-the-go” neck worn devices exhibit seriously impaired performance when utilized in many ordinary outdoor situations. The devices, for example, are unable to deliver a clean air flow to the face of a user, if used in wind speeds of above 1 m/s (about 3.6 km/h). The devices are also highly sensitive to even modest fluctuations in outdoor temperature.

Although greater resilience against wind interference might be possible by implementing a more powerful fan element, this would require significant increase in the size, weight, and power consumption of the devices. For wearable devices however, minimization of these factors is clearly of the utmost priority.

Desired therefore is a wearable air-purification device able to actively deliver purified air for direct inhalation by a user thereby avoiding any breathing resistance issues—but wherein the mechanism for delivery is substantially resistant to interference by wind, as well as operationally stable across a broad range of ambient temperatures.

### SUMMARY OF THE INVENTION

The invention is defined by the claims.

According to an aspect of the invention, there is provided a wearable air purification device for delivering purified air to a region proximal to the mouth and/or nose of a user for their direct inhalation, comprising:

an air chamber, said chamber comprising an opening, and further comprising a flexible diaphragm adapted to deflect between first and second positions, to thereby change a volume within the air chamber, said change of volume inducing a displacement of air in a first direction into the air chamber via the opening when the diaphragm deflects towards said first position and, a displacement of air in a second direction out of the chamber via the opening when the diaphragm deflects towards said second position;

a filtration element located in said air chamber, the filtration element being arranged so as to make fluid communication with air displaced into the air chamber in said first direction through said opening and, to make fluid communication with air displaced out of said chamber in said second direction through said opening so that air is cleaned as it passes both into, and out of, the air chamber.

As the diaphragm moves between the at least first and second positions, air is alternately sucked and blown into and out of the air chamber. Filtration elements, such as for example particle or gas filters, are positioned relative to the openings in the chamber such that incoming and/or outgoing air makes contact with the active surfaces of said filters, and pollutants are removed as it does so.

Where the diaphragm is adapted to oscillate between the two positions at a high frequency, outgoing air can form a jet as it is expelled from the chamber. This is known as synthetic jet generation, and allows for the formation of high velocity air flows using a compact, lightweight, and energy efficient arrangement.

The present invention is based on combining this synthetic jet technology with air filtration functionality, so as to provide an air purifier device which is small and lightweight enough to be worn by a user during day-to-day activities, but which is powerful enough provide full functionality even in conditions of high wind.

The use of a synthetic jet approach means the time air is resident in a filter may be increased.

In some embodiments, the flexible diaphragm may at least partially define a boundary of the chamber.

In this case, the changing of a volume inside the chamber may be achieved through simply varying the eccentricity of the diaphragm. For example, by adapting the diaphragm so as to curve ‘concave-wise’ into the bulk volume of the chamber, the volume of the chamber is reduced. On the other hand, by moving the diaphragm so as to bend ‘convex-wise’ out of the bulk of the chamber, the volume of the chamber is consequently increased. Hence, the synthetic jet action may be achieved within this embodiment by simply ‘flipping’ the diaphragm between out outward ‘convex’ position to an inward ‘concave’ position.

The device may further comprise a driving mechanism for driving the diaphragm to oscillate between two or more positions.

Where synthetic jet action is to be achieved, the device may comprise a driving mechanism for controlling the movement of the diaphragm. For example, the driver unit might comprise elements for inducing electrodynamic displacement of the diaphragm, such as those utilized, for example, within conventional loudspeaker devices. In alternative examples, however, the driver might comprise one or more piezoelectric elements to induce vibrations at frequencies proportional to an applied current or voltage. In further examples still, the driver might comprise one or more motor elements, for mechanical manipulation of the diaphragm.

The surface area of the diaphragm may be greater than the cross-sectional area of any one of the one or more openings/passages.

In such an embodiment, the displacement of gas out of the chamber through an ‘inverting’ of the diaphragm position may naturally lead to the generation of a jet formation, since the pressure wave generated by the movement of the diaphragm has wave front of an area greater than the cross-sectional area of the outlet opening. This may naturally then lead to the generation of vortices as the excess of air is forced through the narrow opening.

The device may comprise two or more air chambers, mutually separated by an at least partially shared boundary, wherein said boundary is at least partially defined by at least one flexible diaphragm.

According this embodiment, the two boundary-sharing chambers work in mutual opposition to one another: when the first chamber is in its sucking phase, the second chamber is in its blowing phase, and vice versa. The diaphragm partially separating the two chambers is effectively shared between the two, and may oscillate between a ‘leftward’ incursion into the bulk volume of the first chamber and a ‘rightward’ incursion into the bulk volume of the second chamber. In this way, the volumes of the two chambers are alternately increased and decreased in concert with one another as the diaphragm moves back and forth.

This embodiment carries the advantage of reducing energy consumption, since a single diaphragm may be used to generate two jets simultaneously.

One or more of the at least one openings may comprise a valve for controlling air flow through the opening.

In this embodiment, valves or switches may be used at the inlets or outlets to control the jet flow. The valves might, for example, comprise very thin metal leafs or plates, which could be easily opened or closed through induced pressure differences alone.

Such an embodiment allows for the use of multiple openings within a single chamber, since the individual openings may be opened or closed during the different phases, allowing for one opening, for example, to function purely as an inlet, and a second opening to function purely as an outlet. This may be valuable in applications, for example, where it is advantageous or necessary for air intake to be drawn from a different relative source within the ambient surroundings to the destination zone of the outgoing air. For example, if the device is to be worn in close proximity to the mouth, it may be desirable to draw air from a source which is not directly in the breathing zone of the user.

According to this embodiment, air cleaning occurs both during the suction phase and during the jet blowing phase, thereby increasing the efficiency of the purification process. Air displaced into the chamber communicates with the filtration elements as it enters the chamber during the sucking phase. As the phase switches and the air-direction reverses, the filtered air part which has already passed through/by the filter surface(s) will once again make contact with the active surfaces of the filters as it passes back out of the chamber. Any air which, at the moment of switching, is in contact with—or resident within the internal channels of—a lateral diffusion filter will continue its diffusion process but in the opposite direction. Hence, this embodiment allows for ‘bi-directional’ cleaning, extending the contact time of pollutants with active surfaces of filtration elements.

The one or more filtration elements may be positioned outside of the at least one air chamber, and aligned with at least one opening, such that air displaced out of the chamber makes fluid communication with the filtration elements as it exits.

According to another aspect of the invention, there is provided a wearable air purification device for delivering purified air to a region proximal to the mouth and/or nose of a user for their direct inhalation, comprising:

an air chamber, said chamber comprising an opening, and further comprising a flexible diaphragm adapted to deflect between two or more positions, to thereby change a volume within the air chamber, said change of volume inducing a displacement of air into and out of the chamber via the opening;

a filtration element arranged so as to make fluid communication with air displaced into and/or out of the air chamber,

flow distribution plates to define an air flow suction zone for the flow of air into the chamber, said air flow suction zone comprising inlet channels leading to the inlet opening, said inlet channels being configured so that they narrow and accelerate the flow of air towards the inlet opening, said flow distribution plates also defining an air flow jetting zone to direct air out of the chamber, and

an impactor, the air flow jetting zone comprising an outlet channel to direct air out of the chamber towards the impactor.

According to this embodiment, filtration elements are arranged such that the outgoing jet makes contact with active filter surfaces after it has left the chamber. This embodiment might in particular be applicable in examples where at least one of the filtration elements is an impaction plate. Here, the outgoing jet, on hitting the impacting plate, changes direction suddenly, inducing, via inertial forces, the separation from the jet of any small particles being carried therein. These may then be captured by the surface of the plate.

The device comprises one or more flow distribution elements, defining one or more air inlet channels for the virtual impaction of gas being displaced into the at least one chamber.

Channels are defined leading up to one or more inlet openings of the chamber. Where these channels are defined sufficiently narrowly, ‘virtual impaction’ is achieved during the sucking phase, wherein air drawn into the chamber, via the inlet channels, is so accelerated by the narrowing of the flow, so that certain larger particles become separated from the air stream, and left behind in the ambient environment.

The air chamber may define an inner chamber within an outer chamber, wherein the space between the inner and outer chambers defines an inlet passageway to the at least one opening. This may define an entrainment pump with more continuous flow stream into and out of the chamber.

A thermal insulation layer may be provided for minimizing heat exchange between the device and the environment.

For certain types of filtration element such as hybrid gas filters impregnated with absorbent/catalytic activated carbon or metal-organic frameworks, cleaning efficiency is strictly limited by temperature and humidity of the ambient environment. For some embodiments, then, it is desirable that the device comprise thermal protection elements in order to maximize performance of filtration components. These elements may comprise an insulating layer, and might, in some examples, comprise heating elements for maintenance of a particular range of optimal temperatures within the device.

According to another embodiment of the invention, there is provided a filter mask structure comprising an array of filter devices as defined above, wherein said array is arranged such that gas displaced out of the air chambers is propelled toward a common region, in close proximity to a user's face, such that the displaced air may be inhaled by said user.

By utilizing an array of devices, clean air may be provided across a broader region, allowing for more comfortable and natural breathing. Additionally, such an arrangement may be more resistant to the effects of wind interference, since wind of a particular directionality will interfere with differently angled flows to different degrees. A high power flow may be maintained, therefore, in winds of different directions.

According to another aspect of the invention, there is provided a method of generating and delivering purified air to the mouth and/or nose of a user, for their direct inhalation, by use of a wearable filter device comprising at least one air chamber, said chamber comprising an opening and further comprising a flexible diaphragm, the method comprising:

deflecting the diaphragm between first and second positions to thereby change a volume within the air chamber, said change of volume inducing a displacement of air in a first direction into the air chamber via the opening when the diaphragm deflects towards said first position and, a displacement of air in a second direction out of the chamber via the opening when the diaphragm deflects towards said second position, and directing said displaced air so as to make fluid communication with one or more filtration elements located in the air chamber so that the filtration element makes fluid communication with air displaced into the air chamber in said first direction through said opening and, makes fluid communication with air displaced out of said chamber in said second direction through said opening, so that air is cleaned as it passes both into, and out of, the air chamber.

Furthermore, the filtration elements utilized within this method may comprise one or more impaction plates, and the method comprises directing air displaced out of the at least one air chamber toward said impaction plates and thereby capturing particular pollutants from said displaced air.

In certain embodiments, the method may further comprise drawing air to be displaced into the at least one air chamber via one or more channels, thereby inducing an elevated inflow speed, and consequently filtering particular pollutants by inertial force.

### BRIEF DESCRIPTION OF THE DRAWINGS

Examples of the invention will now be described in detail with reference to the accompanying drawings, in which:

FIG. 1 is used to explain the known synthetic jet fluid pumping mechanism;

FIG. 2 shows a first example of filter device;

FIG. 3 shows how a device with a single orifice can draw air from a polluted area and deliver fresh air to a desired clean air zone;

FIG. 4 shows a second example of filter device;

FIG. 5 shows a third example of filter device;

FIG. 6 shows a fourth example of filter device;

FIG. 7 shows a fifth example of filter device;

FIG. 8 shows a first example of filter device;

FIG. 9 shows a sixth example of filter device;

FIG. 10 shows a known entrainment pump which makes use of a synthetic jet;

FIG. 11 shows a seventh example of filter device which makes use of an entrainment pump which operates in the manner explained with reference to FIG. 10; and

FIG. 12 shows a set of filter devices applied to a face mask.

### DETAILED DESCRIPTION OF THE EMBODIMENTS

The invention provides a wearable air purification device which actively generates a propelled stream of purified air for direct delivery to a region proximal to a user's mouth or nose for their immediate inhalation. An air chamber comprises a flexible diaphragm adapted to fluctuate between two extreme positions, thereby altering the volume within the chamber and alternately sucking and blowing air into and out of the chamber. Filtration elements are arranged in or about the air chamber, and aligned so as to communicate with air displaced by the diaphragm either on entry or exit from the chamber, for active removal of particulate and/or gaseous pollutants. Embodiments of the invention may comprise a plurality of such air chamber assemblies, arranged so as to collectively deliver a continuous flow of air to a breathing zone of the user.

The invention is based on the concept of incorporating synthetic jet generator technology within a wearable air purification device, so as to provide a purifier capable of delivering a highly propelled stream of clean air to the mouth and/or nose of a user, but while being sufficiently compact and lightweight as to be comfortably worn by a user during day-to-day activities. Synthetic jet generators are finding increasing application within a wide range of technical fields—most notably the area of cooling for LED devices. The use of synthetic jets is promising due to a number of significant advantages over conventional fan-based technology, including lower noise level, higher reliability, longer lifetime, better efficiency, lower cost and compact and flexible form factor. It is noted that given the wide application of synthetic jet technology—particularly in LED devices—implementation of synthetic jet generators in mass production is already feasible.

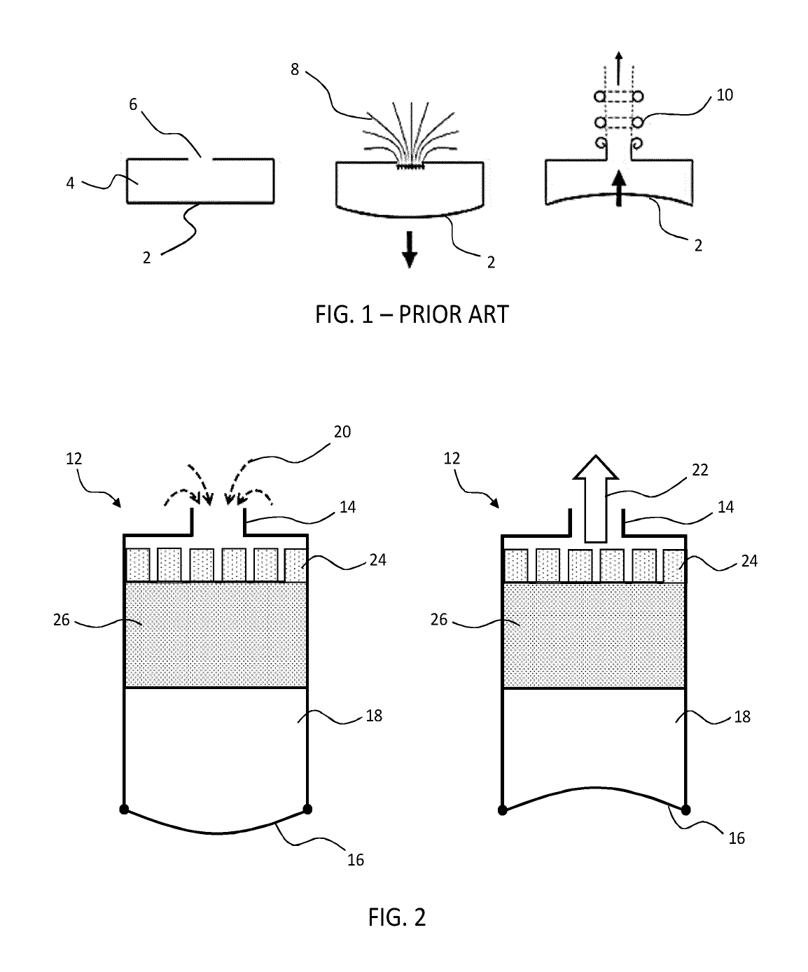

In FIG. 1 is shown a simple example of the synthetic jet generator concept, as known in the art. A synthetic jet generator comprises a vibrating membrane 2 (most commonly sinusoidal vibration) forming a cavity 4, which is connected to the ambient via an orifice or tube 6. The oscillation of this membrane, which can be driven by any means, for example electrodynamic (as in a conventional loudspeaker), piezoelectric, or mechanical, causes air to be alternately sucked in and blown out of the cavity at a certain frequency. During the inlet (suction) phase, air 8 is drawn into the cavity from all directions. During the outlet (blowing) phase, jet formation 10 can occur, wherein a vortex is generated as air is forced through the narrow opening 6. The membrane vibration frequency can be tuned with a control unit, for example, and a high jet velocity is in general achievable, ranging from between several m/s and tens of m/s.

As discussed above, the performance and efficiency of state of the art “on-the-go” (e.g. neck-worn) air cleaning products are seriously impaired when such devices are used in many typical outdoor environments. Simulations have found that a state of the art device is unable to deliver clean air to the face—whether the air source is placed above or below the head—in an oncoming wind of 1 m/s. Even if the air source could be re-positioned closer to the wearer's nose/mouth, a higher flow rate would still be required, necessitating a higher power fun unit within the device, which would consequently incur added bulk and weight to the overall unit.

Embodiments of the present invention combine synthetic jet technology with existing air purification and filtration technologies, to provide an efficient way of delivering clean air at a flow rate of up to tens of m/s for example around 50 m/s, in a unit which is compact and lightweight (in comparison with fan-based devices of equivalent flow-capacity).

In FIG. 2 is shown a schematic illustration of a simple first example. An air chamber 12 comprises an opening or passage 14 at one end, and a flexible diaphragm 16 at the other, the diaphragm 16 adapted to flip or invert between two extreme positions, the first position illustrated in the left-most diagram of FIG. 2, and the second position illustrated in the right-most diagram of FIG. 2. The diaphragm partially defines the outer boundary of the chamber, isolating the lower portion of its interior, occupied by air cavity 18, from the exterior surrounding environment. The upper portion of the chamber is occupied by two stacked filtration elements: particle filter layer 24, and gas filter layer 26, each of which spans the entire width of the chamber, and together form a boundary between the inlet 14 at the top of the chamber and the air cavity 18 which fills the remainder of the chamber.

By way of example, the filters may comprise one or more of:

a micro corrugated MERV 12 (minimum efficiency reporting value of 12) HEPA (“high efficiency particulate absorption) filter (which may remove over 90% PM2.5);

an activated carbon fiber filter for removing gas pollutants; or

a hybrid activated carbon fiber and glass fiber filter (for both particular matter and gases); or

an activated carbon foam;

an electret foam.

As the diaphragm moves back and forth between its first and second positions, it alternately sucks and blows air into and out of the chamber. The suction phase is shown in the left-most diagram of FIG. 2. As the diaphragm moves from its upward-facing (second) position to its down-ward facing (first) position, the volume of air cavity 18 is correspondingly altered, increasing from the smaller volume shown in the right-hand figure, to the larger volume shown in the left-hand figure. This change of volume induces a vacuum effect, sucking air 20 into the chamber through inlet opening 14. The inwardly displaced air is forced through filter elements 24, 26, during which pollutants (particles and harmful gases) are subsequently adsorbed/absorbed. Note that the transport of pollutants in the filters is in some embodiments accomplished at least partially through diffusion, and air purification/filtration is typically an irreversible process.

The diagrams of FIG. 2 are not shown to scale, and so typically the filtration elements may occupy a volume of the chamber which is only a small proportion of that occupied by air cavity 18. In this case, the change of volume induced by the movement of the diaphragm 16 to its first position may in general be greater than that of the two filter elements combined, and hence during the sucking phase, some air is forced through the filter layers and into the cavity 18. In other examples, however, the diaphragm size and the filtration element volumes may be calibrated such that the change in volume induced by the inversion of the former substantially matches that of the latter, so that the air drawn into the chamber fills the inner spaces and cavities of the filter elements, but does not penetrate into lower cavity 18.

The blowing phase is illustrated by the right-most diagram of FIG. 2. As the diaphragm moves from its first position to its second position, the cavity volume is decreased and air is expelled as shown by arrow 22.

In this example, the diaphragm partially defines a boundary of the chamber so that the diaphragm position and shape determines the chamber volume.

In this example, the diaphragm is adapted to move between at least two extreme positions. In preferred embodiments, the diaphragm is adapted to oscillate, or vibrate, between these two positions, thereby facilitating a synthetic jet action. For this purpose, the device additionally comprises a driver unit for driving the oscillation or vibration of the diaphragm. The driver unit could, for example, comprise elements for inducing electrodynamic displacement of the diaphragm, such as those utilized, for example, within conventional loudspeaker devices. In alternative examples, however, the driver might comprise one or more piezoelectric elements to induce vibrations at frequencies proportional to an applied current or voltage. In further examples still, the driver might comprise one or more motor elements, for mechanical manipulation of the diaphragm. Other embodiments comprising different driver mechanisms are also conceivable.

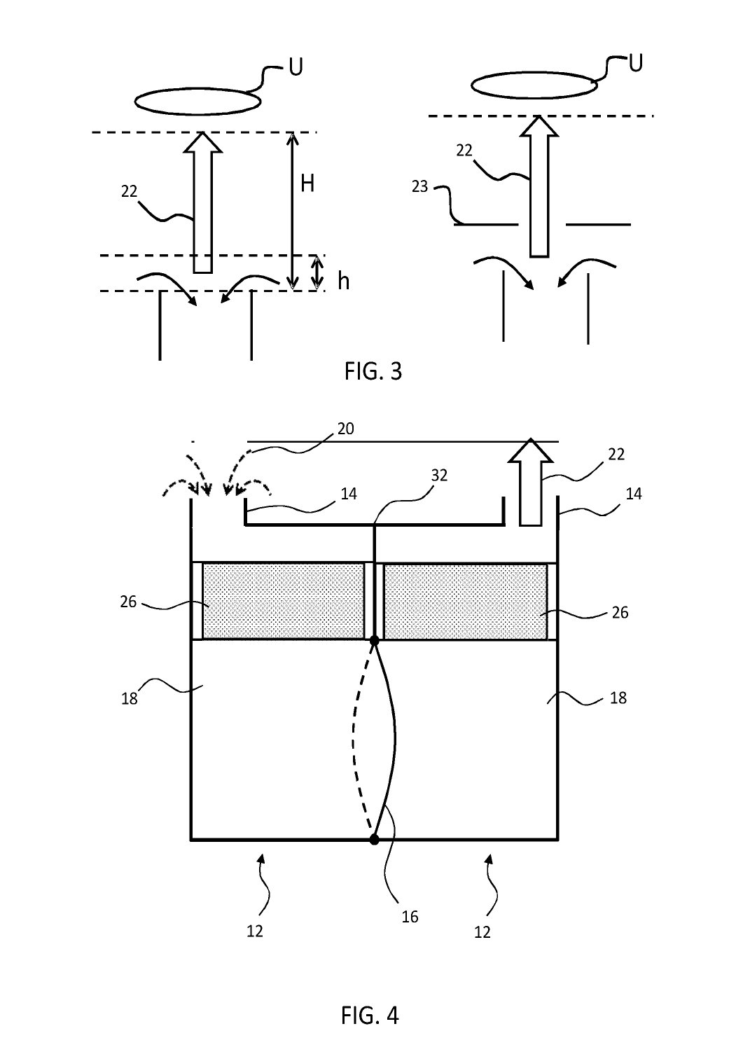

FIG. 3 is used to explain possible driver arrangements. In the left image in FIG. 3, the mouth of the user is at location U. This is at a distance H from the synthetic jet orifice. However, the inhalation by the user results in inhalation of a layer of air of depth h, which is much smaller. The high speed of the synthetic jet enables the jet to reach the mouth of the user at a much greater distance than the distance from which air is drawn into the cavity 18. As a result, interference between air drawn in to the cavity and the expelled air for breathing can be avoided by suitable design of the distance between the synthetic jet and the user's mouth.

The right image in FIG. 3 shows that an orifice plate 23 may be placed downstream of the synthetic jet outlet so that air is drawn in from the nozzle side of the plate 23 but is breathed in by the user from the other side of the plate.

In this way, a single orifice can function as both the inlet and outlet, while enabling polluted air to be drawn in to the air purifier from one location, and the clean air expelled to another location for breathing by the user.

Depending on the structure and composition of the diaphragm, which may vary according to different embodiments, the movement of the diaphragm between its first and second positions might comprise a smooth, continuous transition—wherein the diaphragm occupies all intermediary positions as it moves relatively smoothly between the two, or alternately might comprise a stochastic, or discontinuous movement, wherein the diaphragm ‘flips’ suddenly from one position to another.

In the particular example of FIG. 2, the filtration elements 24, 26 are positioned on the inside of the air chamber 12, and aligned with the one opening 14, such that air displaced into the chamber 20 makes fluid communication with the filtration elements as it enters. With this embodiment, air is cleaned not only during its passage into the chamber, but additionally during its passage back out again, since the air must pass through the same single opening 14, and hence through the adjacent filtration elements, during both phases of travel. As the phase switches and the air-direction reverses, the filtered air part which has already passed through/by the filter surface(s) will once again make contact with the active surfaces of the filters as it passes back out of the chamber. Any air which, at the moment of switching, is in contact with—or resident within the internal channels of—a lateral diffusion filter will continue its diffusion process but in the opposite direction.

Hence, this embodiment allows for ‘bi-directional’ cleaning, extending the contact time of pollutants with active surfaces of filtration elements.

The vibrating-membrane frequency (f) is tunable with a control unit. A high jet-out velocity (tens of m/s) of clean air can be achieved by choosing f and its corresponding dimension of cavity and orifice.

The frequency of a synthetic jet generator in for example tens of kHz, such as 26 kHz. To avoid noise, generally the frequency is selected above the lower frequency limit of ultrasound (˜20 kHz).

For all indoor/outdoor air cleaners, the gas and particle filters will need maintenance. The synthetic jet cavity should be designed in such a way that these filters can easily be replaced.

FIG. 4 shows a second example. The same reference numbers are used as in FIG. 2 for the same components. FIG. 4 also shows that the cavity 18 may contain only a gas filter; the use of a particle filter and a gas filter is not essential.

The device comprises two air chambers 18, mutually separated by a shared boundary which is defined by the flexible diaphragm 16. Essentially, the device of FIG. 4 comprises two devices 12 of FIG. 2 side by side, with the flexible membrane 16 forming a connection between them. The coupling of the two devices is partially achieved with the membrane 16 and partially with a rigid wall part 32.

The two boundary-sharing chambers 18 work in mutual opposition to one another: when the first chamber is in its sucking phase, the second chamber is in its blowing phase, and vice versa. The diaphragm partially separating the two chambers is effectively shared between the two, and may oscillate between a ‘leftward’ incursion into the bulk volume of the first chamber and a ‘rightward’ incursion into the bulk volume of the second chamber. In this way, the volumes of the two chambers are alternately increased and decreased in concert with one another as the diaphragm moves back and forth.

This design enables a reduction in energy consumption, since a single diaphragm may be used to generate two jets simultaneously. In particular, both the suction phase (sucking half-cycle) and blowing phase (jetting half-cycle) of the synthetic jet are employed for air purification and filtration.

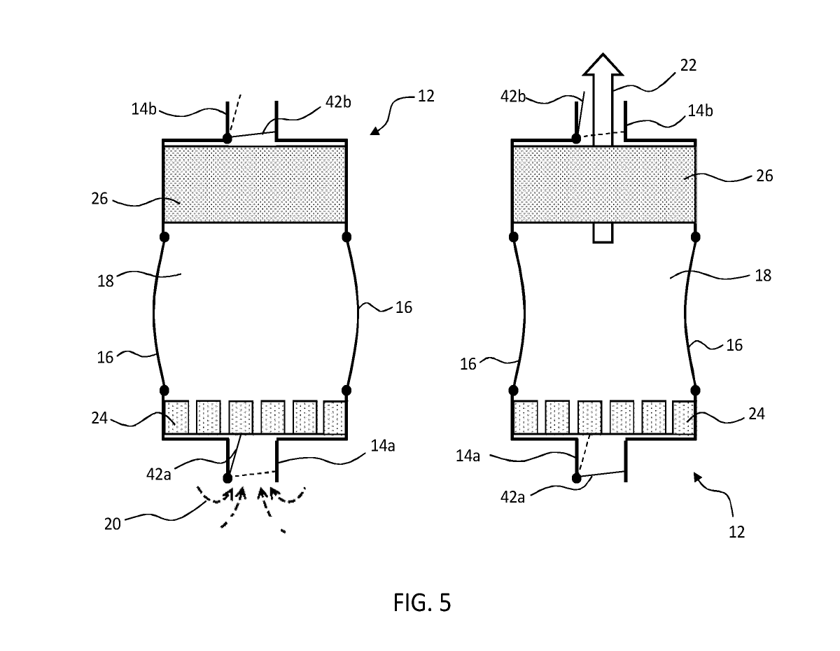

The examples above are high frequency devices. Low frequency devices are also possible. FIG. 5 shows a third example for operating at lower frequencies. Again, the same reference numbers are used as in FIG. 2 for the same components.

This example has a separate air intake 14a and air outlet 14b. The air intake 14a has an inlet valve 42a and the air outlet 14b has an outlet value 42b.

The valves 42a,42b may be flap valves which open and close in dependence on the pressure difference across them. The flap valves may be thin metal leafs or plates. Other valves may be used, and they may be passive (such as flap valves) or active (i.e. switched valves). The valves control the jet flow.

In this example the gas filter 26 is at the inlet side and the particle filter 24 is at the outlet side. The chamber 12 is defined in the space between the filters 24,26.

When valves are used, a relatively low frequency may be desired to enable the desired mechanical response of the valves to open and close in time with the synthetic jet. For example the vibrating-membrane frequency may be below 10 Hz, for example in the range 1-5 Hz.

In the suction phase shown in the left of FIG. 5, the inlet valve 42a opens and the outlet valve 42b closes. Subsequently, air is drawn in the inlet orifice 14a, passing through the particle filter 24, and enters the cavity 18. In the jet blowing phase shown in the right of FIG. 4, the inlet valve 42a closes and the outlet valve 42b opens. Air is forced to pass through the gas filter 26 before is it blown out.

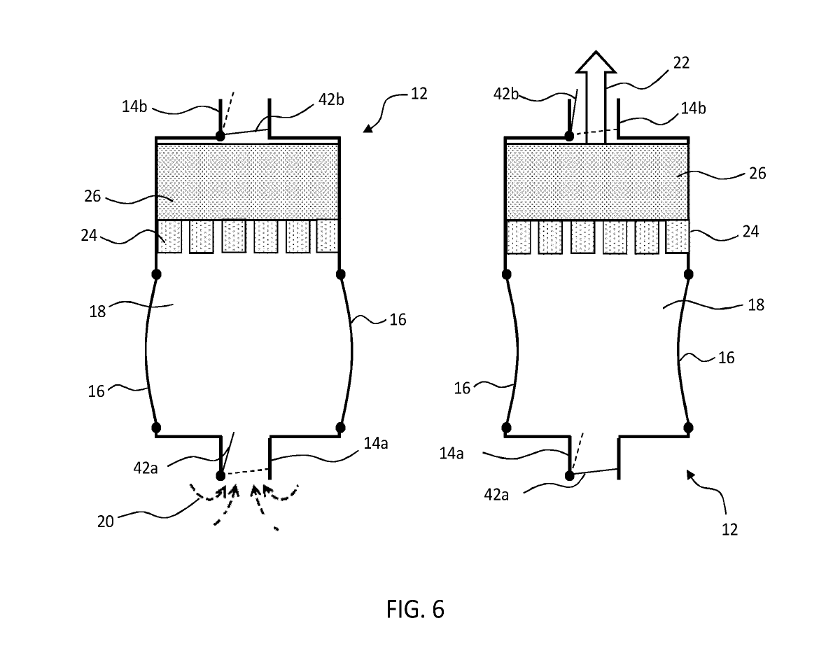

FIG. 6 shows a fourth example. This differs from the example of FIG. 5 only in that both filters 24,26 are provided at the outlet side of the chamber 12.

Usually, removal of a gaseous pollutant is carried out with a filter impregnated with a particular absorbent for the target gas. There are some absorbents/catalysts such as activated carbon and metal-organic frameworks (MOFs), which can be impregnated in a hybrid gas filter, and thus can filter out more than one type of gaseous pollutants. However, the cleaning efficiency of these filters is strictly limited by temperature and humidity of the ambient surroundings in which the air cleaner is working. For “on-the-go” applications, the negative impact of temperature fluctuation on cleaning performance should be minimized.

For an indoor air cleaner, there is a narrow typical temperature range of 18° C.˜30° C. For an outdoor face mask application, the air cleaner needs to work well in both winter and summer time, for which the temperature range should be extended to 0° C.-40° C.

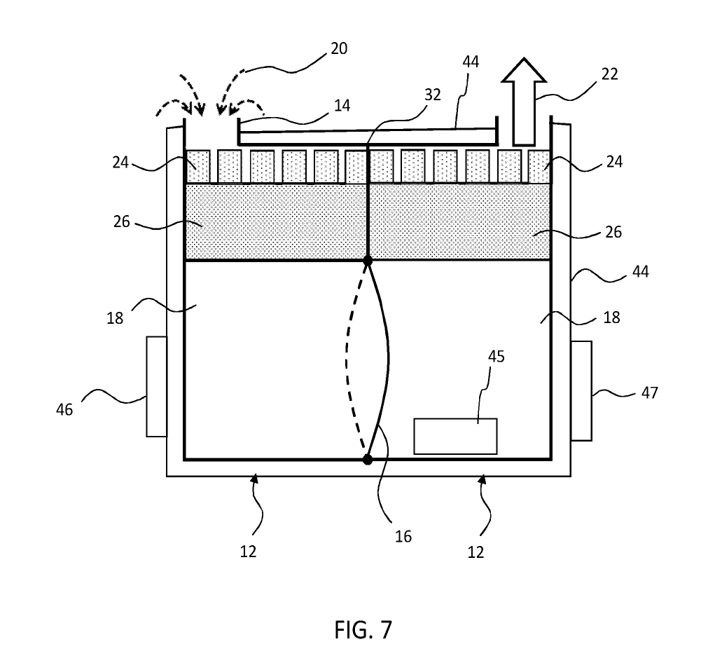

FIG. 7 shows a modification to FIG. 3 and shows thermal alterations to protect the air cleaner when working in a harsh environment. In winter time, a thermal isolation layer 44 (e.g. a plastic cover) is added to minimize the heat exchange between the cleaning device and environment. A small heat source 45 (e.g. resistor heater) may also be provided inside the air cleaner. Part of the energy of a battery source 46 can then be used to keep the cleaner warm when the wearer goes out.

In the summer time, the thermal isolation 44 may be removed and the heater 45 is idle. If the ambient temperature is too high, instead of heating, a means of cooling or ventilation may also be provided. The battery can be charged using a solar (photovoltaic) panel 47 mounted on the outside of the air cleaner. The battery also provides the power for driving the membrane.

The battery may be part of the device as shown, but it may be part of another device, such as a smart phone, to which the air purifier device is connected in order to receive power.

Another type of filtering approach which may be used is an impactor. This is a filter technology for separating particles of a certain size from a gas stream.

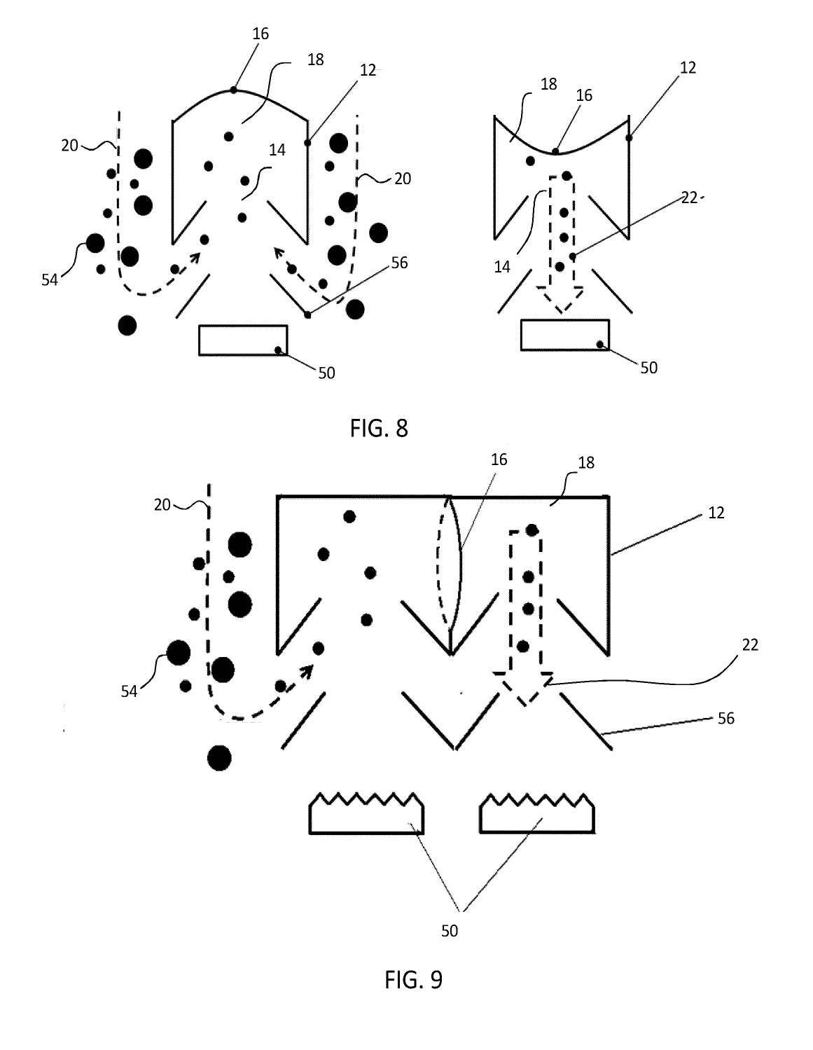

FIG. 8 shows an example of a filter device which makes use of the synthetic jet approach described above, and also implements a two-stage impaction for the removal of polluted airborne particles.

As in the examples above, there is a chamber 12 which has a volume which depends on the position of a diaphragm 16. Air is drawn in to the inlet/outlet 14 laterally, as shown by air flow 20. Particles 54 are entrained in the air flow.

A plate 56 functions as a simple flow distributor, and it separates the flow into a sucking zone into the chamber 12 and a jetting zone directly beneath the inlet/outlet 14. A high velocity air jet is directed out of the inlet/outlet 14, and the jet velocity can be controlled by changing the vibrating frequency. The device further comprises an impaction plate 50.

During the sucking half-cycle shown in the left of FIG. 8, air is drawn into the chamber 12. A virtual impactor is naturally formed between the chamber 12 and the plate 56, which means that large particles 54 will be left outside the device as schematically shown. Only small particles will follow the sucked air stream and enter the chamber 12.

During the jetting half-cycle shown in the right of FIG. 7, the air previously sucked into the cavity is pushed out rapidly to form the high velocity jet. Once it hits the impaction plate 50 and changes direction, small particles in the jet are separated via inertial force and captured by the impaction plate 50. Since the maximum velocity of the jet is high enough (several m/s to tens of m/s), particles of very small aerodynamic diameter may be removed as well.

Thus, each half-cycle of the device performs a particle filtering operation. During the sucking half-cycle large particles with high inertia are separated from the air stream via the first virtual impaction. During the jetting half-cycle, the remaining small particles are further removed by the second impaction of the high-velocity jet flow on the impactor. Thus, a two-stage impactor filtering function is implemented.

In this example, no filters are needed (as well as no fan in common with the examples above) and the synthetic jet generator can be very compact. The air purification system can thus be very small, lightweight and energy efficient. It is also washable and easy for maintenance. By using inertial force to remove particles, there is secondary pollution.

The design includes a synthetic jet generation part and one or more impaction parts contained within the air purification system. The physical impactor 50 is in the jetting zone and the virtual impactor (which follows from the flow directions) is in the sucking zone. The flow distributor 56 separates the synthetic jet into a sucking zone and jetting zone. It also plays a role in forming the virtual impactor in the sucking zone.

As explained above and shown in FIG. 3, two (or more) devices can be coupled together with a share membrane. FIG. 9 shows how two of the designs of FIG. 8 can be coupled together in a similar manner. Again, this can reduce the energy consumption because both the suction phase (sucking half-cycle) and blowing phase (jetting half-cycle) of synthetic jet are employed for air purification. The removal of small particles in the second impaction stage can be further improved with surface modification of the impaction plate 50.

A practical limitation of some examples of synthetic jet arrangement may be that the available resident time of the air in the filters is too short for sufficient purification. The resident time can be increased by lowering the synthetic jet frequency, for example as explained above for the examples using valves to control the inlet and outlet. However, this can compromise the flow rate of the air purifier.

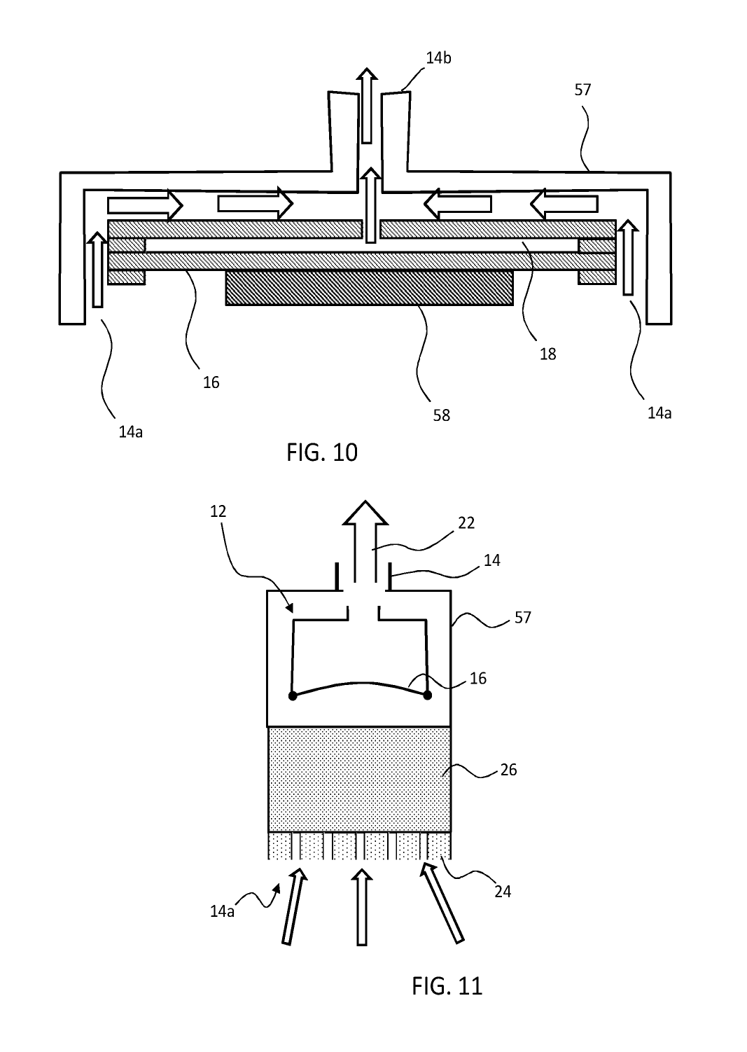

Another approach is to use a synthetic jet driven entrainment pump as shown in FIG. 10. The pump again has a cavity 18 which has a wall defined by a flexible membrane 16. The cavity of the synthetic jet generator is surrounded by an additional enclosure 57. The inlet 14a is defined by the space between the synthetic jet generator and the enclosure 57 on one side of the pump, whereas the outlet 14b is aligned with the synthetic jet outlet, and on the opposite side of the pump. The momentum of the fluid stream generated by the synthetic jet generator causes air to be sucked in continuously from the one side of the pump enclosure, and to be expelled continuously at the other side of the enclosure. Such pumps are commercially available for example the product known as the “microblower” from Murata.

FIG. 10 shows a piezoelectric element 58 as the device for providing oscillation of the membrane 16.

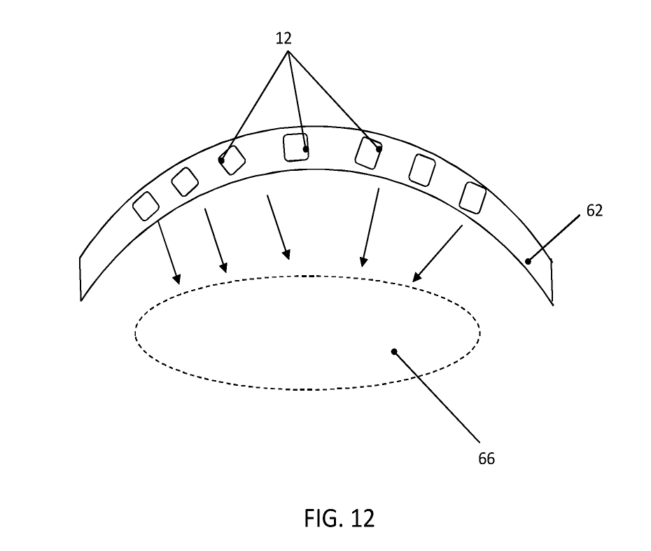

FIG. 11 shows an air purification device based on a synthetic jet entrainment pump, suing the same reference numbers as in FIG. 10 for the same components. The air drawn in through the inlet passes through the filters 24, 26 before passing between the outer enclosure 57 and in the inner enclosure formed by the outside of the synthetic jet pump chamber 12. The resident time of the air in the filters can be increased in this design while maintaining a high synthetic jet frequency, since the resident time is independent of the frequency. The expelled purified air again forms a far reaching jet.

The outer enclosure is used to define a channel arrangement leading to the inlet of the synthetic jet. Thus, the air chamber 12 defines an inner chamber within an outer chamber 57, wherein the space between the inner and outer chambers 12,57 defines an inlet passageway to the opening 14. This inlet passageway is longer than the more direct path taken by the outlet air stream out of the air purification device.

FIG. 12 shows how an array of synthetic jet impactors 12 may be fabricated on a thin sheet via MEMS technique. Then this sheet can be used as a mask which can ‘breathe’ and deliver clean air to the wearer 66. The array can also be fabricated on a strip.

The device can be worn over the face of the user, to deliver a continuous stream of fresh air to be breathed. Between breaths, the air flow can fill the mask volume, with the previous volume displaced so it leaks to the outside. Thus, the mask is not sealed to the face of the user.

Thus, the preferred implementation of the wearable air purification device of the invention is formed as part of a mask, which is worn over the mouth or the nose and mouth of the user. The synthetic jet arrangement is formed within the mask or forms part of the structure of the mask, so that it can be worn by the user rather than carried by the user. As explained above, it may be powered by its own power source, or else it may tap power from another device. Where it has its own power supply, it may be rechargeable, using integrated harvesting of solar energy. It may instead use the movement of the user as a mechanism for generating energy for charging the system.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A wearable air purification device for delivering purified air to a region proximal to the mouth and/or nose of a user for their direct inhalation, comprising:
a synthetic jet generator comprising:
an air chamber, said chamber comprising an opening, and further comprising a flexible diaphragm adapted to deflect between first and second positions to thereby change a volume within the air chamber, said change of volume inducing a displacement of air in a first direction into the air chamber via the opening when the diaphragm deflects towards said first position and, a displacement of air in a second direction out of the chamber via the opening when the diaphragm deflects towards said second position;
a filtration element located in said air chamber, the filtration element being arranged so as to make fluid communication with air displaced into the air chamber in said first direction through said opening and, to make fluid communication with air displaced out of said chamber in said second direction through said opening so that air is cleaned as it passes both into, and out of, the air chamber.

2. An air purification device as claimed in claim 1, wherein the flexible diaphragm at least partially defines a boundary of the chamber.

3. An air purification device as claimed in claim 1, further comprising a driving mechanism for driving the diaphragm to oscillate between two or more positions.

4. An air purification device as claimed in claim 1, wherein the surface area of the diaphragm is greater than the cross-sectional area of any one of the one or more openings.

5. An air purification device as claimed in claim 1, comprising two or more air chambers, mutually separated by an at least partially shared boundary, wherein said boundary is at least partially defined by at least one flexible diaphragm.

6. An air purification device as claimed in claim 1, wherein one or more of the at least one openings comprise a valve for controlling air flow through the opening.

7. An air purification device as claimed in claim 1, wherein the air chamber defines an inner chamber within an outer chamber, wherein the space between the inner and outer chambers defines an inlet passageway to the at least one opening.

8. (canceled)

9. An air purification device as claimed in claim 1, further comprising a thermal insulation layer for minimizing heat exchange between the device and the environment.

10. A filter mask structure comprising:
an array of filter devices each as claimed in claim 1, wherein said array is arranged such that air displaced out of the air chambers is propelled toward a common region, in close proximity to a user's face, such that the displaced air may be inhaled by said user.

11. A method of generating and delivering purified air to the mouth and/or nose of a user, for their direct inhalation, by use of a wearable filter device comprising a synthetic jet generator comprising at least one air chamber, said chamber comprising an opening and further comprising a flexible diaphragm, the method comprising:
deflecting the diaphragm between first and second positions to thereby change a volume within the air chamber, said change of volume inducing a displacement of air in a first direction into the air chamber via the opening when the diaphragm deflects towards said first position and, a displacement of air in a second direction out of the chamber via the opening when the diaphragm deflects towards said second position, and directing said displaced air so as to make fluid communication with one or more filtration elements located in the air chamber so that the filtration element makes fluid communication with air displaced into the air chamber in said first direction through said opening and, makes fluid communication with air displaced out of said chamber in said second direction through said opening, so that air is cleaned as it passes both into, and out of, the air chamber.

12. A method as claimed in claim 11, wherein the filtration elements comprise one or more impaction plates, the method comprising directing air displaced out of the at least one air chamber toward said impaction plates and thereby capturing particular pollutants from said displaced air.

13. A method as claimed in claim 12, further comprising drawing air to be displaced into the at least one air chamber via one or more channels, thereby inducing an elevated inflow speed, and consequently filtering particular pollutants by inertial force.
